(19) United States
(12) Patent Application Publication
(10) Pub. No.: US 2010/0045535 A1
(43) Pub. Date: Feb. 25, 2010

(54) FLAT ANTENNA DEVICE

(75) Inventors: Chih-Hao Lin, Taipei (TW); Keng-Chih Lin, Taipei (TW); Yi-Cheng Lin, Taipei (TW)

Correspondence Address: EDWARDS ANGELL PALMER & DODGE LLP, P.O. BOX 55874, BOSTON, MA, 02205, US

(73) Assignee: NATIONAL TAIWAN UNIVERSITY, Taipei (TW)

(21) Appl. No.: 12/359,331

(22) Filed: Jan. 25, 2009

(30) Foreign Application Priority Data
Aug. 25, 2008 (TW) 97132343

(51) Int. Cl. H01Q 9/04

(52) U.S. Cl. 343/700 MS

(57) ABSTRACT

A flat antenna device is proposed, including a substrate having a first surface and a second surface, a first. antenna module disposed on the first surface and having a first coupling unit, and a second antenna module disposed on the second surface and having a second coupling unit. The first and second coupling units are parallel and coupled to one another so as to constitute a transmission line structure, allowing signals passing through the first coupling unit to be coupled and fed into the second coupling unit such that a first resonant signal and a second resonant signal of approximately 910 MHz and 1710 MHz are generated through the transmission line structure and a hook-shaped radiation unit of the second antenna module and a third resonant signal of approximately 2400 MHz is generated through an open electromagnetic coupling groove formed in the second module, thereby providing a compact and low-cost flat antenna device for use with six commonly used frequency bands of GSM, GPS, DCS, PCS, UMTS and WLAN IEEE-802.11b/g/n.

### BACKGROUND OF THE INVENTION

1. Field of the Invention

The present invention generally relates to flat antenna devices, and more particularly, to a double-sided printed circuit board flat antenna device.

2. Description of the Prior Art

Portable wireless communication products have become quite popular nowadays. Accordingly, antennas having small dimensions and operable over multiple frequency bands have become a research focus in the design fields of portable wireless communication products.

Conventionally, a double planar coupling antenna has been provided, which operates over the commonly used frequency bands in the mobile phone wireless communication system through adjustment of the frequency response of the antenna.

Taiwan Patent No. 1273735 discloses a double-layer stack type antenna disposed above a printed circuit board, wherein the antenna comprises a first radiation board and a second radiation board stacked over the first radiation board, wherein the second radiation board has a fixed shape and size. By changing the size of the first radiation board, the resonant frequency of the antenna can be slightly adjusted such that the antennal can operate within two commonly used frequency bands: GSM900 (Global System for Mobile Communication) and DCS1800 (Digital Communication System).

However, since the overall size of the first and second radiation boards is big, the printed circuit board is required, and the first and second radiation boards and the printed circuit board need to be spatially disposed, the antenna occupies a relatively large amount of space in wireless communication devices such as mobile phones.

As such, it is desirable and beneficial to provide a more compact antenna covering multiple frequency bands. Further, by analyzing the correspondence relationship between the antenna structure and frequency responses, slight adjustments of the antenna can be made to obtain required frequency bands.

### SUMMARY OF THE PRESENT INVENTION

In view of the above drawbacks of the prior art, the present invention provides a flat antenna device covering multiple frequency bands and further the correspondence relationship between the antenna structure and frequency responses is analyzed so as such that slight adjustments of the antenna can be made so as to obtain required signal frequency bands.

The present invention provides a flat antenna device, which comprises: a substrate having a first surface and a second surface parallel to the first surface; a first antenna module disposed on the first surface and having a first coupling unit and an end radiation unit; and a second antenna module disposed on the second surface and having a second coupling unit and a hook-shaped radiation unit. The hook-shaped radiation unit further comprises first, second and third portions.

The first and second coupling units are parallel and coupled to one another, thus forming a transmission line structure. It should be noted that in the transmission line structure, the first and second coupling units should have matched equivalent transmission impedances and even have identical lengths and widths for allowing input signals of the first coupling unit to be coupled to the second coupling unit and further transmitted to the second antenna module.

The flat antenna device of the present invention further comprises a signal feed-in unit formed on the first surface and a ground unit formed on the second surface, wherein the signal feed-in unit comprises a first feed-in portion and a second feed-in portion, and the ground unit comprises a first rectangular portion and a second rectangular portion.

The second feed-in portion of the signal feed-in unit is connected to the first coupling unit for feeding original signals into the first coupling unit and the first antenna module. The second rectangular portion of the ground unit is connected to the second coupling unit for providing the flat antenna device with good grounding. It should be noted that the third portion of the hook-shaped radiation unit is not connected with the second rectangular portion, thereby forming an open electromagnetic coupling groove in the second antenna module.

The second coupling unit and the hook-shaped radiation unit of the second antenna module collectively radiate a first resonant mode signal. The hook-shaped radiation unit radiates a second resonant mode signal, and the open electromagnetic coupling groove formed in the second antenna module is coupled to generate a third resonant mode signal.

In other words, the total length of the second coupling unit and the first, second and third portions of the hook-shaped radiation unit determine the frequency response of the first resonant mode. The total length of the first, second and third portions of the hook-shaped radiation unit determines the frequency response of the second resonant mode. The length of the third portion of the hook-shaped radiation unit determines the frequency response of the third resonant mode.

In summary, in the present invention, signals are coupled and fed to the second coupling unit through the first coupling unit, and a first resonant mode signal at 910 MHz and a second resonant mode signal at 1710 MHz are generated through the second coupling unit in combination with the hook-shaped radiation unit of the second antenna module, and a third resonant mode signal at 2400 MHz is generated through the open electromagnetic coupling groove formed in the second antenna module, thereby providing a compact and low-cost flat antenna device operable over six commonly used frequency bands of GSM, GPS, DCS, PCS, UMTS and WLAN IEEE-802.11b/g/n.

The present invention provides a flat antenna device having a relatively compact size and covering multiple frequency bands that are commonly used by mobile phones. Further, the flat antenna device can be slightly adjusted according to the correspondence relationship between the antenna structure and the frequency responses so as to provide users with desired frequency bands.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view illustrating the structure of a flat antenna device in accordance with the present invention;

FIG. 2 is a “front” view illustrating the structure of the first surface of the flat antenna device in accordance with the present invention;

FIG. 3 is a “rear” view illustrating the structure of the second surface of the flat antenna device in accordance with the present invention;

FIG. 4 is a measured frequency response graph for a RF signal of the flat antenna device in accordance with the present invention; and

FIG. 5 is a graph of the frequency response affected by the ground unit.

### DETAILED DESCRIPTION OF THE PREFERRED EMBODIMENT

The following illustrative embodiments are provided to illustrate the disclosure of the present invention. The details of the specification may be changed on the basis of different points and applications, and numerous modifications and variations can be devised without departing from the spirit of the present invention.

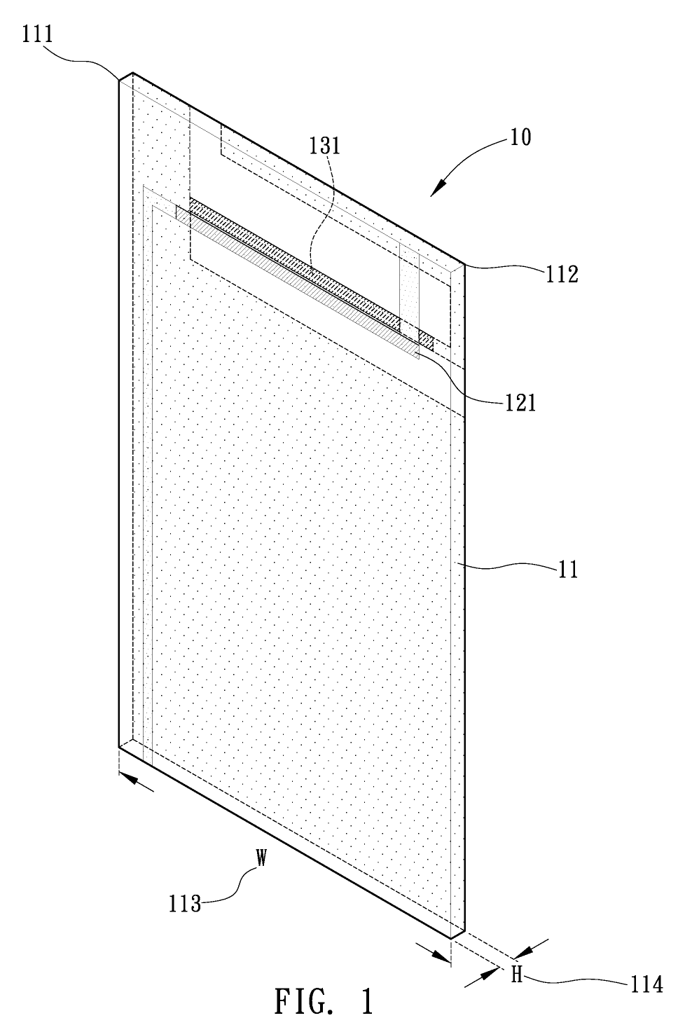

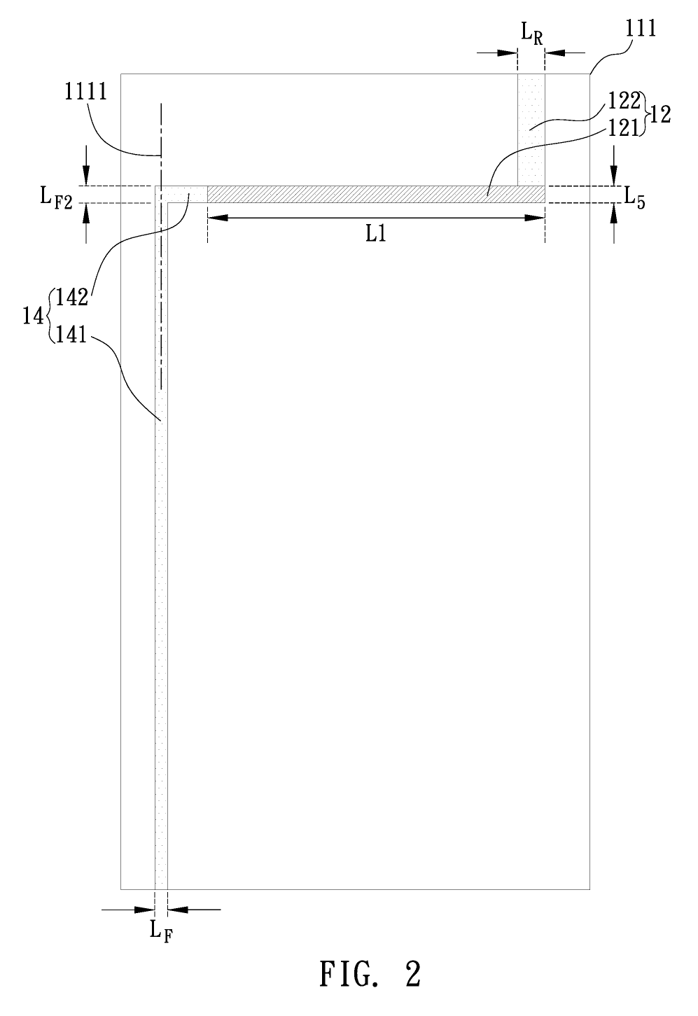

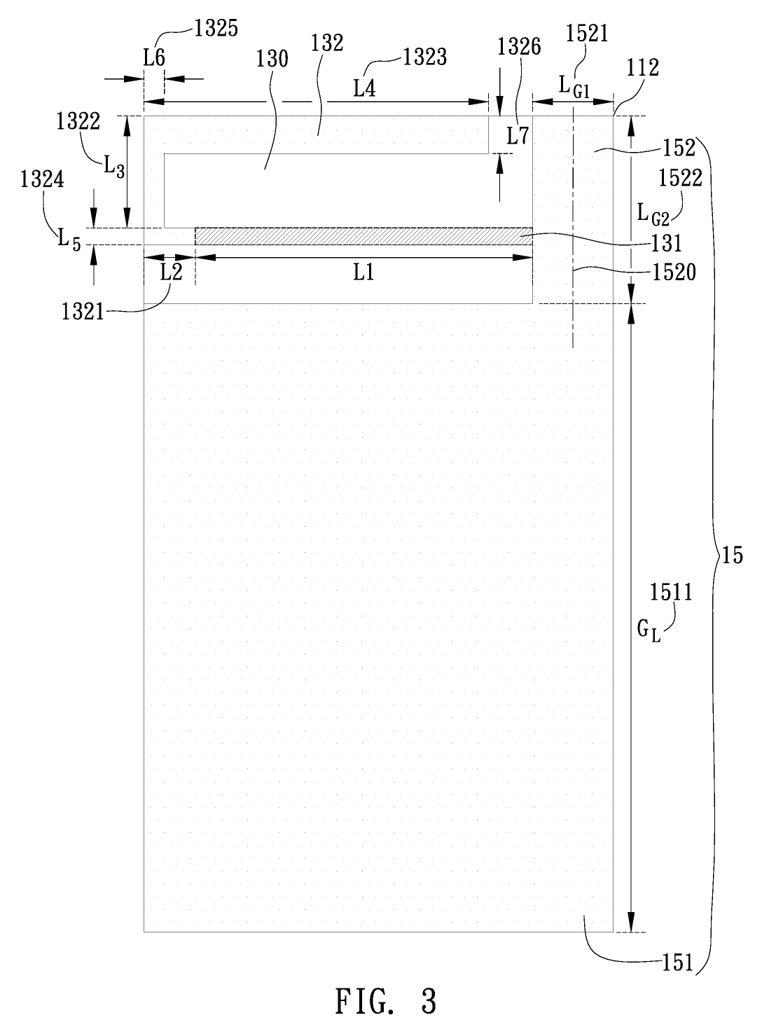

Referring to FIG. 1 through FIG. 3, FIG. 1 is a perspective view illustrating the structure of a flat antenna device according to the present invention, FIG. 2 shows the structure of the first surface of the flat antenna device, and FIG. 3 shows the structure of the second surface of the flat antenna device. It should be noted that dashed lines in FIGS. 2 and 3 are only used for illustrating positional relations of components of the flat antenna device and do not physically exist in the flat antenna device. Moreover, printed circuits of the flat antenna device may have an integrally formed structure.

As shown in the drawings, the flat antenna device 10 proposed by the present invention comprises: a substrate 11 having a first surface 111 and a second surface 112 parallel to one another, a first antenna module 12 disposed on the first surface 111 and having a first coupling unit 121 and an end radiation unit 122 perpendicular to the first coupling unit 121, and a second antenna module 13 disposed on the second surface 112 and having a second coupling unit 131 and a hook-shaped radiation unit 132.

The first and second coupling units 121, 131 are parallel and coupled to one another so as to constitute a transmission line structure as depicted by two sets of diagonal slashes in FIG. 1), wherein the first and second coupling units 121, 131 have identical length L1 and width, thereby allowing input signals of the first coupling unit 121 to be coupled to the second coupling unit 131 and further transmitted to the second antenna module 13.

The hook-shaped radiation unit 132 further comprises first, second and third portions (not shown). Although the first, second and third portions are not clearly defined in the drawings, since antenna effects are often adjusted by changing the lengths and widths of line sections, the lengths and widths of the three portions are denoted as follows: the length 1321 of the first portion is L2, the length 1322 of the second portion is L3 and the length 1323 of the third portion is L₄, the width of the first portion is L₅, the width of the second portion is L₆ and the width of the third portion is L₇, which sufficiently shows the positions of the third portions.

The flat antenna device 10 of the present invention further comprises a signal feed-in unit 14 formed on the first surface 111 and a ground unit 15 formed on the second surface 112, wherein the signal feed-in unit 14 comprises a first feed-in portion 141 and a second feed-in portion 142, and the ground unit 15 comprises a first rectangular portion 151 and a second rectangular portion 152.

The second feed-in portion 142 of the signal feed-in unit 14 is connected to the first coupling unit 121 for feeding original signals into the first coupling unit 121 and the first antenna module 12. The second rectangular portion 152 of the ground unit 15 is connected to the second coupling unit 131 for providing the flat antenna device 10 with good grounding. It should be noted that the third portion of the hook-shaped radiation unit 132 of the second antenna module 13 does not connect with the second rectangular portion 152, thereby forming an open electromagnetic coupling groove 130 in the second antenna module 13.

Since coupling interaction also exists between the first feed-in portion 141 and second rectangular portion 152, the first feed-in portion 141 is preferably disposed along an axis 1111 on the first surface 111 that is the projection of a first symmetrical axis 1 520 of the second rectangular portion 152 along the normal line of the second surface 112.

The second coupling unit 131 of the second antenna module 13 along with the hook-shaped radiation unit 132 collectively radiates a first resonant mode signal. The hook-shaped radiation unit 132 radiates a second resonant mode signal, and the open electromagnetic coupling groove 130 formed in the second antenna module 13 is coupled to generate a third resonant mode signal, wherein the coupling sensing area of the open electromagnetic coupling groove 130 is related to the length 1323 of the third portion.

In other words, the frequency response of the first resonant mode is determined by the sum of the length of the second coupling unit 131 and lengths 1321, 1322, 1323 of the first, second and third portions; the frequency response of the second resonant mode is determined by the sum of the lengths 1321, 1322, 1323 of the first, second and the third portions; and the frequency response of the third resonant mode is determined by the length 1323 of the third portion.

It should be noted that a first rectangular edge 1511 (G_{L}) of the first rectangular portion 151 of the ground unit 15 will generate a fourth resonant frequency variation in the antenna signal of the flat antenna device 10. The longer the length of the first rectangular edge 1511, the lower is the fourth resonant frequency. That is, the fourth frequency response for a signal of the flat antenna device can be varied by changing the length of the first rectangular edge 1511.

As described above, a printed circuit fabrication process is preferably employed so as to form printed circuits of the first and second antenna modules 12, 13, the feed-in unit 14 and the ground unit 15 on the first and second surfaces 111, 112, respectively.

In a preferred embodiment for instance, the substrate 11 has a width 113 (w) of 45 mm and a height 114 (h) of 0.6 mm; both the first and second coupling units 121, 131 have a width L₅ of 1.6 mm; the widths of the first, second and third portions 1324 (L₅), 1325 (L₆), 1326 (L₇) are 1.6 mm, 2 mm and 3.5 mm, respectively; and the width (L_{R}) of the end radiation unit 122 is 2.5 mm.

The width (L_{F1}) of the first feed-in portion 141 of the signal feed-in unit 14 is 1.1 mm; both the second feed-in portion 142 and the first coupling unit 121 have a width (L_{F2}) of 1.6 mm; the length (L_{G1}) of the third rectangular edge 1521 of the second rectangular portion 152 of the ground unit 15 is 8 mm, and the length (L_{G2}) of the fourth rectangular edge 1522 is 5.7 mm plus the length of the second portion of the hook-shaped radiation unit 132, thereby providing a compact and low-cost flat antenna device for use with the six commonly used frequency bands of GSM, GPS, DCS, PCS, UMTS and WLAN IEEE-802.11b/g/n.

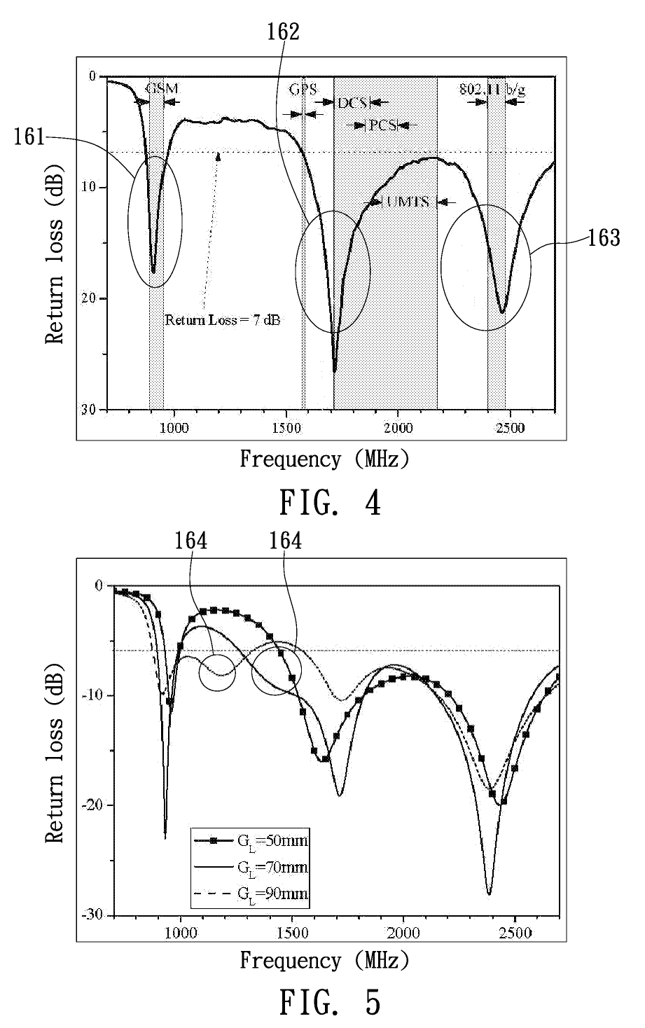

It should be noted that the size, ratio of each component and/or the wireless frequency band signals are provided for illustrative purpose only and is not intended to limit the present invention in any way. FIG. 4 is a measured frequency response graph for a RF signal of the flat antenna device. As shown in the graph, the frequency response of the first resonant mode 161 of the flat antenna device 10 is 910 MHz, the frequency response of the second resonant mode 162 is 1710 MHz and the frequency response of the third resonant mode 163 is 2400 MHz.

FIG. 5 shows the frequency response affected by the ground unit. As shown in the graph, when the first rectangular edge 1511 of the ground unit 15 has a length between 50 mm and 90 mm, the frequency response of the fourth resonant mode 164 varies between 1000 MHz and 1400 MHz.

Therefore, in the present invention, signals are coupled and fed to the second coupling unit 131 through the first coupling unit 121, and a first resonant mode signal at 910 MHz and a second resonant mode signal at 1710 MHz are generated through the second coupling unit 131 in combination with the hook-shaped radiation unit 132 of the second antenna module 13, and a third resonant mode signal at 2400 MHz is generated through the open electromagnetic coupling groove 130 formed in the second antenna module 13, thereby providing a compact and low-cost flat antenna device operable over six commonly used frequency bands of GSM, GPS, DCS, PCS, UMTS and WLAN IEEE-802.11b/g/n.

The present invention provides a flat antenna device 10 having a relatively compact size and covering multiple frequency bands that are commonly used by mobile phones. Further, the flat antenna device can be slightly adjusted according to the correspondence relationship between the antenna structure and the frequency responses so as to provide users with desired frequency bands.

While illustrative embodiments are provided in the above description, such embodiments are for illustration of the principles and functions of the present invention only and they are not to be construed restrictively. Various modifications and variations of the present invention will be obvious to those skilled in the art and yet still fall within the spirit and scope of the invention as set forth in the following claims.

What is claimed is:

1. A flat antenna device, comprising:
a substrate having a first surface and a second surface;
a first antenna module disposed on the first surface and having a first coupling unit and an end radiation unit; and
a second antenna module disposed on the second surface and having a second coupling unit and a hook-shaped radiation unit, wherein the first and second coupling units are parallel and coupled to one another.

2. The device according to claim 1, wherein the first coupling unit is perpendicular to the end radiation unit.

3. The device according to claim 1, wherein the first and second surfaces are parallel to one another.

4. The device according to claim 1, wherein the first and second coupling units have identical length and width.

5. The device according to claim 1, wherein the hook-shaped radiation unit comprises first, second and third portions, and a total length of the first coupling unit and the first, second and third portions of the hook-shaped radiation unit determines a frequency response of a first resonant mode of the flat antenna device.

6. The device according to claim 5, wherein the frequency response of the first resonant mode is 910 MHz.

7. The device according to claim 5, wherein the second antenna module radiates signals in the first resonant mode.

8. The device according to claim 5, wherein a total length of the first, second and third portions of the hook-shaped radiation unit determines a frequency response of a second resonant mode of the flat antenna device.

9. The device according to claim 8, wherein the hook-shaped radiation unit radiates signals in the second resonant mode.

10. The device according to claim 8, wherein the frequency response of the second resonant mode is 1710 MHz.

11. The device according to claim 5, wherein a length of the third portion determines a frequency response of a third resonant mode of the flat antenna device.

12. The device according to claim 11, further comprising an electromagnetic coupling groove formed in the second antenna module for generating the signals in the third resonant mode.

13. The device according to claim 11, wherein the frequency response of the third resonant mode is 2400 MHz.

14. The device according to claim 5, wherein the widths of the first, second and the third portions are 1.6 mm, 2 mm and 3.5 mm, respectively.

15. The device according to claim 1, further comprising a signal feed-in unit formed on the first surface of the substrate and connected to the first coupling unit, and a ground unit formed on the second surface and connected to the second coupling unit.

16. The device according to claim 15, wherein the ground unit comprises a first rectangular portion and a second rectangular portion and is connected to the first coupling unit via the second feed-in portion, and the signal feed-in unit comprises a first feed-in portion and a second feed-in portion and is connected to the second coupling unit via the second rectangular portion.

17. The device according to claim 16, wherein the second rectangular portion comprises a first symmetrical axis, and the first feed-in portion is disposed on a corresponding axis on the first surface which is the projection of the first symmetrical axis of the second rectangular portion along a normal line of the second surface.

18. The device according to claim 16, wherein the first rectangular portion comprises a first rectangular edge and a second rectangular edge, and a length of the first rectangular edge is used to adjust a fourth frequency response of the flat antenna device.

19. The device according to claim 16, wherein the width of the first feed-in portion of the signal feed-in unit is 1.1 mm, and the widths of the second feed-in portion and the first coupling unit are 1.6 mm.

20. The device according to claim 1, wherein the substrate has a width of 45 mm and a height of 0.6 mm, both the first and second coupling units have a width of 1.6 mm, and the width of the end radiation unit is 2.5 mm.
